(19) United States
(12) Patent Application Publication
(10) Pub. No.: US 2018/0176635 A1
(43) Pub. Date: Jun. 21, 2018

(54) REPRODUCING A PREDETERMINED PROGRAM CONTENT OF BROADCAST PROGRAMS

(71) Applicant: Preh Car Connect GmbH, Dresden (DE)

(72) Inventors: Rico STAUDE, Dresden (DE); Frank BÜTTNER, Dresden (DE)

(73) Assignee: Preh Car Connect GmbH, Dresden (DE)

(21) Appl. No.: 15/841,983

(22) Filed: Dec. 14, 2017

(30) Foreign Application Priority Data
Dec. 17, 2016 (DE) 10 2016 015 130.7

(51) Int. Cl. H04N 21/433; H04N 5/775; H04N 21/4335; H04N 21/4402; H04N 21/454

(52) U.S. Cl. CPC H04N 21/4334; H04N 5/775; H04N 21/454; H04N 21/4402; H04N 21/4335

(57) ABSTRACT

The present disclosure relates to a method for reproducing broadcast programs by a broadcast receiver device. The method includes: receiving a broadcast program by a receiving unit, checking, if an actual program content of the received broadcast program corresponds to a predetermined program content, by a calculating unit, buffering the received broadcast program in the reproduction buffer unit, as long as the actual program content corresponds to the predetermined program content, reproducing the buffered broadcast program by a reproduction unit with a reproduction velocity, which is lower than a receiving velocity, with which the buffered broadcast program was received, and tuning the receiving unit to another broadcast program, so that instead of the received broadcast program the other broadcast program will be received, as soon as one of the actual program content does not correspond to the predetermined program content.

This application claims priority to the German Application No. 10 2016 015 130.7, filed Dec. 17, 2016, now pending, the contents of which are hereby incorporated by reference.

The present disclosure relates to a method and a broadcast receiver device for reproducing predetermined program contents of broadcast programs.

A user of a broadcast receiver device frequently wishes only a specific program contents, for example only music, to be reproduced. However, program contents are frequently interrupted by other program contents. For example, voice parts, which the user is not interested in, are frequently output between pieces of music. In order to avoid reproduction of unwanted program contents, it is frequently required to manually change the broadcast program, which, for the user, is arduous and time consuming.

Thus, the object of the present disclosure is to provide a method and a broadcast receiver device for reproducing broadcast programs allowing for the reproduction of a predetermined program content during an extended period of time, without any operative action of a user.

According to the present disclosure, this object will be solved by the features of claim 1 in view of the method, and by the features of claim 13, in view of the broadcast receiver device.

Embodiments of the present disclosure are the subject matter of the subclaims.

The method for reproducing broadcast programs according to the present disclosure is performed by means of a broadcast receiver device, which comprises a receiving unit, a reproduction buffer unit, a reproduction unit and a calculating unit. The method comprises the steps of: (a) receiving a broadcast program by means of the receiving unit,
(b) checking, by means of the calculating unit, if an actual program content of the received broadcast program corresponds to a predetermined program content,
(c) buffering the received broadcast program in the reproduction buffer unit, as long as the actual program content corresponds to the predetermined program content,
(d) reproducing the buffered broadcast program by means of the reproduction unit with a reproduction velocity, which is lower than a receiving velocity, with which the buffered broadcast program was received, and
(e) tuning the receiving unit to another broadcast program, so that, instead of the received broadcast program, the other broadcast program will be received, as soon as the actual program content corresponds to the predetermined program content.

The method allows for the reproduction of a predetermined program content of a plurality of broadcast programs by means of a broadcast receiver device without manual operative action, without another program content to be reproduced. For this, the received broadcast program is automatically changed, if the program content of the actually received broadcast programs does not correspond any more to the predetermined program content. For example, the received broadcast program will be changed, if instead of music, voice content is received. Moreover, the received broadcast program is buffered in a reproduction buffer unit, as long as the actual program content corresponds to the predetermined program content, and is reproduced with a reproduction velocity, which is lower than the receiving velocity, with which the buffered broadcast program was received. In other words, the buffered broadcast program is reproduced in a delayed manner.

By receiving velocity, a range of audio information and/or video information may be understood, which will be received by a broadcast receiver device within a specified time span. By reproduction velocity, a range of audio information and/or video information may be understood, which will be reproduced by a broadcast receiver device within a specified time span. The amount of audio information and/or video information is, for example, a number of audio data and/or video data, or an amount of audio material and/or video material.

If the reproduction velocity is smaller than the receiving velocity of a specified range of audio information and/or video information, the reproduction extends over a longer time span than it was provided on the transmitter side. This, for example, may be achieved by an expansion of the audio information or the video information, respectively.

It is to be noted that the receiving velocity and/or the reproduction velocity of audio information, which comprises a music content, may be characterized by the so called “pace.” The pace, among others, may be represented as a “beats per minute” unit.

The delayed reproduction of the buffered broadcast program, on the one hand, allows for the reproduction buffer unit to be refilled while receiving the broadcast program, and, on the other hand, reduces the velocity, with which a fill level of the reproduction buffer unit decreases, if no broadcast program is actually received, the program contents of which corresponds to the predetermined program contents. In this way, the reproduction buffer unit shall be kept from running empty, so that upon changing the broadcast program or search of another broadcast program the predetermined program contents may continue to be reproduced. In other words, it is avoided that reproduction of the predetermined program contents is interrupted by emptying the reproduction buffer unit, while, upon changing the broadcast program, it is searched for another broadcast program. Thus, the present disclosure allows for automated limitation of the reproduction of broadcast programs to a predetermined program content by avoiding interruptions of the reproduction.

In one embodiment of the present disclosure, the steps (b) to (e) will be performed once again. This embodiment allows for continued limitation of the reproduction of broadcast programs to a specified predetermined program content. For this, another change of the broadcast program is performed, as soon as the program contents thereof does not correspond any more to the predetermined program contents, to another broadcast program, the program contents of which corresponds to the predetermined program contents.

In another embodiment of the present disclosure, the reproduction velocity is set depending of a fill level of the reproduction buffer unit. For example, the reproduction velocity is increased with increasing fill level of the reproduction buffer unit, in order to achieve approximation of the reproduction velocity to the receiving velocity. Thus, falsification caused by reducing the reproduction velocity of the audio signal is allowed to be reduced and to increase reproduction quality. Moreover, the reproduction velocity may be reduced as the fill level decreases, to refill the reproduction buffer unit or to avoid emptying of the reproduction buffer unit.

In another embodiment of the present disclosure, the change of the reproduction velocity is realized by means of a scanning conversion of the buffered broadcast program. Alternatively, change of the reproduction velocity is realized by application of a time-stretching algorithm or a combination of a scanning conversion and a time-stretching algorithm to the buffered broadcast program. This especially allows for audio features of the broadcast program, such as a sound pitch, to largely be maintained, irrespective of the delayed reproduction of the broadcast program and thus to reproduce the broadcast program in a delayed manner, without significant losses of the audio quality.

In another embodiment of the present disclosure, the buffered broadcast program is only reproduced, if a fill level of the reproduction buffer unit is larger than a predetermined fill level. In this way, the reproduction buffer unit is it is advantageously prevented from rapidly and frequently running empty due to low fill levels, and reproduction of the predetermined program contents is prevented from frequently become interrupted by this.

In another embodiment of the present disclosure, a user of the broadcast receiver device sets a broadcast program or several broadcast programs, and one of the broadcast programs set is selected as the other broadcast program. In this way, the user is advantageously be enabled to adapt the selection of the broadcast programs to his preferences and interests. For example, the user may adapt the selection to his taste in music, if the predetermined program contents is music, or to adapt the selection to topics he is interested in, if the predetermined program contents are voice contents.

In another embodiment of the present disclosure, a user of the broadcast receiver device rates a broadcast program or several broadcast program and one of the rated broadcast programs is selected according to the rating as the other broadcast program. In this way, the selection may advantageously be adopted to the preferences and interests of the users.

In another embodiment of the present disclosure, for each broadcast program or for each one of several broadcast programs, a probability is determined, that a program content of the broadcast program corresponds to the predetermined program contents, and one of the broadcast programs is selected as the other broadcast program depending of the probabilities. In this way, the risk of running empty of the reproduction buffer unit upon a change of the broadcast program is reduced, before another broadcast program is being found, the program contents of which corresponds to the predetermined program contents. Thus, the probability of interruptions of the reproduction of the predetermined program contents due to running empty of the reproduction buffer unit is reduced.

In another embodiment of the present disclosure, buffering of the received broadcast program is continued, after the reproduction of the buffered broadcast program has been interrupted. In this way, the reproduction buffer unit may be filled during interruption of the reproduction of the buffered broadcast program. The interruption may, for example, be caused by an operative action of a user of the broadcast receiver device.

In another embodiment of the present disclosure, following tuning of the receiving unit to the other broadcast program, reproduction of the buffered broadcast program is continued. In this way, an interruption of reproduction of the predetermined program contents during search of another broadcast program, the program contents of which corresponds to the predetermined program contents, is advantageously avoided.

In another embodiment of the present disclosure, the predetermined program contents comprise no voice or the predetermined program contents comprise no music. This embodiment of the present disclosure is directed to frequently encountered user preferences, whishing either not to listen to music or not to listen to voice content.

In another embodiment of the present disclosure, the received broadcast program is reproduced, wherein an operative action of a user of the broadcast receiver device causes the receiving unit to be tuned to the other broadcast program, so that, instead of the reproduced broadcast program, the other broadcast program will be received, the reproduction buffer unit will be emptied and the broadcast program reproduced until the operative action is not taken into account for a predetermined time span during execution of step (e). This embodiment of the present disclosure allows for a user to independently terminate reproduction of a broadcast program and to cause a change to another broadcast program, for example if he dislikes the broadcast program actually reproduced. The requirement of a time span, in which the broadcast program that has been reproduced until operative action, will not be taken into account during execution of step (e), avoids re-reproducing of the broadcast program, as long as the program contents thereof will not change.

In another embodiment of the present disclosure, an operative action of a user may cause a portion of a buffered broadcast program will not be reproduced and instead, the reproduction is being continued in a portion of the broadcast program to be subsequently received, without the receiving unit being tuned to another broadcast program or the broadcast program having been reproduced until operative action is taken will not be taken into account for a predetermined time span during execution of step (e). I.e. a portion of the buffered broadcast programs will be “skipped” during reproduction. Said portion may instantaneously be removed from the reproduction buffer unit or may firstly remain therein. This procedure especially applies, if a reproduction buffer unit, besides a piece of music having been reproduced until the operative action is taken, also comprises program contents that have been received following the piece of music.

The broadcast receiver device according to the present disclosure for reproducing broadcast programs comprises a receiving unit, a calculating unit, a reproduction buffer unit and a reproduction unit. The receiving unit is designed for receiving a broadcast program and tuning to another broadcast program, so that, instead of the received broadcast program, the other broadcast program will be received as soon as an actual program content of the received broadcast program does not correspond to a predetermined program content. The calculating unit is designed for checking, if an actual program content of a broadcast program received by the receiving unit corresponds to a predetermined program content. The reproduction buffer unit is designed for buffering a broadcast program received by the receiving unit, as long as an actual program content of the received broadcast program corresponds to a predetermined program content. The reproduction unit is designed for reproducing a broadcast program buffered in the reproduction buffer unit with a reproduction velocity, which is lower than a receiving velocity, with which the buffered broadcast program was received by the receiving unit.

The broadcast receiver device according to the present disclosure allows for performing the method of the present disclosure. Thus, the advantages of the broadcast receiver device according to the present disclosure correspond to the above-mentioned advantages of the method of the present disclosure.

Embodiments of the present disclosure will be explained in detail in the following by way of drawings,

wherein:

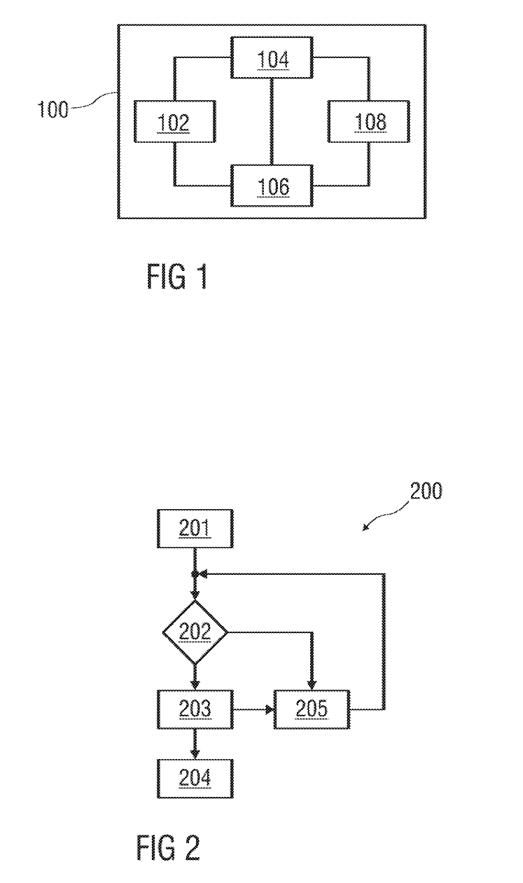

FIG. 1 schematically shows a broadcast receiver device for reproducing broadcast programs according to the present disclosure, and

FIG. 2 shows a flow chart of a method of the present disclosure for reproducing broadcast programs.

FIG. 1 schematically shows a broadcast receiver device 100 for reproducing broadcast programs according to the present disclosure. The broadcast receiver device is for example a radio apparatus or a radio navigation apparatus, for example a radio navigation apparatus of a vehicle. The broadcast receiver device 100 comprises a receiving unit 102, a calculating unit 104, a reproduction buffer unit 106 and a reproduction unit 108. Besides, the broadcast receiver device 100 may still comprise other components, which are not shown in FIG. 1.

The receiving unit 102 is designed for receiving a broadcast program and tuning to another broadcast program, so that, instead of the received broadcast program, the other broadcast program will be received, as soon as an actual program content of the received broadcast program does not correspond to a predetermined program content.

The calculating unit 104 is designed for checking, if an actual program content of a broadcast program received by the receiving unit 102 corresponds to a predetermined program content. Analyzing methods that are suitable for this are known from the art, for example methods for real-time differentiation of music and voice contents.

The reproduction buffer unit 106 is designed for buffering or caching a broadcast program received by the receiving unit 102, as long as an actual program content of the received broadcast program corresponds to a predetermined program content. The reproduction buffer unit 106, for example, comprises a so-called FIFO buffer storage (FIFO=First In-First Out), by means of which data stored in the FIFO buffer storage may be output to the reproduction unit 108 in the same order, in which the data were stored in the FIFO buffer storage.

The reproduction unit 108 is designed for reproducing a broadcast program buffered in the reproduction buffer unit 106 with a reproduction velocity, which is lower than a receiving velocity, with which the buffered broadcast program was received by the receiving unit 102. In addition, the reproduction unit 108 may reproduce a buffered broadcast program with a reproduction velocity, which corresponds to a receiving velocity, with which the buffered broadcast program was received by the receiving unit 102.

FIG. 2 shows a flow chart 200 of a method of the present disclosure comprising the process steps 201 to 205 for reproducing broadcast programs by means of the broadcast receiver device 100 from FIG. 1.

Prior to the first process step 201, a program content is predetermined. For example, music is predetermined as a program content, so that the predetermined program content does not comprise a pure voice content. Or, as a program content, a voice content is predetermined, so that the predetermined program content does not comprise a pure music content. However, in both cases, the predetermined program content may comprise a mixture of voice content and music. Alternatively, as a program content, pure voice content or pure music content may be predetermined, so that the predetermined program content does not comprise a mixture of voice content and music. Or, as a program content, a mixture of voice content and music is predetermined, so that the predetermined program content does comprise neither pure voice content nor pure music.

For example, the program content is predetermined by a user of the broadcast receiver device 100. For this, the broadcast receiver device 100 may comprise an operating mode enabling the user to select a program content among various program contents, for example music, voice content, pure music, pure voice content or a mixture of music and voice content. Alternatively or in addition, the broadcast receiver device 100 may have a factory-predetermined program content that is used as long as no other program content is predetermined by a user.

In the first process step 201, the receiving unit 102 is tuned to a broadcast program, so that the broadcast program will be received by means of the receiving unit 102. Tuning may be done manually, for example, by means of an operative action of a user, or may be done automatically, for example, upon enabling the broadcast receiver device 100. Following the first process step 201, the method is continued by the second process step 202.

In the second process step 202, it will be checked by means of the calculating unit 104, if an actual program content of the received broadcast program corresponds to the predetermined program content. If the actual program content corresponds to the predetermined program content, the method is continued by the third process step 203. Otherwise, i.e. if the actual program content of the received broadcast program does not correspond to the predetermined program content, the method is continued by the fifth process step 205, so that the receiving unit 102 is tuned to another broadcast program.

In the third process step 203, the received broadcast program is buffered by means of the reproduction buffer unit 106, i.e. it is cached, as long one of the actual program contents of the received broadcast program corresponds to the predetermined program. Simultaneously, in the second process step 202, already-started checking of the actual program content of the received broadcast program is being continued. If the actual program content of the received broadcast program does not correspond (any more) to the predetermined program content, the buffering procedure is discontinued and the method is being continued by the fifth process step 205, so that the receiving unit 102 is tuned to another broadcast program.

The third process step 203 may be configured such that a program portion of the received broadcast program is transmitted to the reproduction buffer unit 106 for buffering not before the program portion has been checked. For buffering or caching the program portion during the checking operation, respectively, a checking buffer unit (not shown) may be provided upstream to the reproduction buffer unit 106, the content of which is not provided for reproduction. In this way, it is assured that exclusively program portions are buffered (and reproduced) with the predetermined program content.

In the fourth process step 204, the buffered broadcast program is reproduced by means of the reproduction unit 108. If the reproduction buffer unit 106 has not completely been filled, the reproduction velocity may be slightly lower than a receiving velocity, with which the buffered broadcast program was received. If the reproduction buffer unit 106 has completely been filled, the reproduction velocity may correspond to a receiving velocity, with which the buffered broadcast program was received.

The fourth process step 204 is started as soon as the reproduction buffer unit 106 is completely filled or has reach a predetermined minimum fill level. The fourth process step 204 is performed as long as one of the reproduction buffer unit 106 comprises a buffered broadcast program. In other words, the fourth process step 204 is performed until the reproduction buffer unit 106 has run empty. Hence, performing the fourth process step 204 may be continued, when buffering of the received broadcast program in the reproduction buffer unit 106 was discontinued or interrupted, the receiving unit 102 is tuned to another broadcast program or is checked, if an actual program content of another broadcast program corresponds to the predetermined program content. I.e., the fourth process step 204 is performed independently of the simultaneous buffering, changing or checking of a received broadcast program.

The fifth process step 205 is performed as soon one of the actual program content of the received (and possibly buffered) program does not correspond (any more) to the predetermined program content. In the fifth process step 205, the receiving unit 102 is tuned to another broadcast program, so that instead of the broadcast program received so far, the other broadcast program will be received. In other words, the broadcast program that has been received is changed. Simultaneously, the broadcast program buffered in the reproduction buffer unit 106 may continue to be reproduced (fourth process step 204).

Following the fifth process step 205, the method may be continued by the second process step 202, so that the process steps 202 to 205 will be repeated. Simultaneously, the broadcast program buffered in the reproduction buffer unit 106 may continue to be reproduced (fourth process step 204).

It is possible that the process steps 202 to 205 are repeated a plurality of times in the manner as set forth above, especially if the broadcast receiver device 100 receives and reproduces broadcast programs over an extended period of time.

The other broadcast program, which the receiving unit 102 is tuned to in the fifth process step 205, may be selected by way of program listing of broadcast programs which is managed by the calculating unit 104 or by the receiving unit 102. The program listing may depend of the predetermined program content, for example, for each of the program content, which is able to predetermined, separate program listing may be provided. Accordingly, the receiving unit 102 may be tuned, according to the order of the broadcast programs in the program, to the respective broadcast program, until the actual program content of a received broadcast program corresponds to the predetermined program content. In other words, the program listing is searched for a broadcast program comprising the predetermined program content. If none of the broadcast programs of the program listing should comprise the predetermined program content, the program listing will again be searched in the same order.

Alternatively, in tuning the receiving unit 102 to the other broadcast program, any broadcast program of the program listing may randomly be selected. As another alternative, that broadcast program of the program listing may be selected, latest reproduction of which is the least recent one.

The method may provide that the program listing is established by the user and/or is changed by the user. For example, the broadcast receiver device 100 may enable the user to establish the program listing by selecting broadcast programs. Alternatively or in addition, the broadcast receiver device 100 may enable a user to change an existing program listing by deleting a broadcast program from the program listing or by the addition of a broadcast program to the program listing. In this way, the user is enabled to adapt the program listing to his musical preferences, if the predetermined program content is music, or to topics, which are of interest to him, if the predetermined program content is a voice content.

Alternatively or in addition, the present disclosure may provide for the user of the broadcast receiver device 100 to rate a broadcast program or several broadcast programs, and in the fifth process step 205, a broadcast program to be selected depending on this rate, wherein the receiving unit 102 being tuned to that broadcast program. For example, the user may be enabled to assign a rating number selected among a group consisting of a predetermined amount of rating numbers to a broadcast program, for example, a group consisting of the rating numbers 1 to 5. Broadcast programs having higher ratings will be preferred in selecting the broadcast program. For example, the order of the broadcast programs in the program listing is set depending on the rating of the broadcast programs.

Alternatively or in addition, the method may provide that for a broadcast program or for each of several broadcast programs a probability is determined, that a program content of the broadcast program corresponds to the predetermined program content, and that in process step 205, a broadcast program is selected depending on that probability, the receiving unit 102 being tuned to that broadcast program. For example, the order of the broadcast programs in the program listing is set depending on the probabilities that a program content of the respective broadcast program corresponds to the predetermined program content. In that in selecting the broadcast program the probability is taken into account that a program content of the broadcast program corresponds to the predetermined program content, the risk of running empty of the reproduction buffer unit 106 upon a change of the broadcast program, before another broadcast program is to be found, the program content of which corresponds to the predetermined program content, is reduced. In this way, the probability of interruptions of reproduction of the predetermined program content due to running empty of the reproduction buffer unit 106 is reduced.

In order to determine the probability if a program content of a broadcast program corresponds to them predetermined program content, a relative frequency may be detected, wherein tests performed in the past, if the program content of the broadcast program corresponds to the predetermined program, have result in a positive outcome. Moreover, the probability, wherein a program content of a broadcast program corresponds to the predetermined program content, may be determined separately for different time intervals and/or for different weekdays. In this way, it may be taken into account that, for example, news programs or commercial breaks are frequently broadcast at set times and that specific program contents are frequently transmitted at set broadcast times, i.e. at specified times and/or on specified weekdays.

For example, the relative frequencies of positive test results for a broadcast program are separately established for each hour of a weekday, so that for one weekday 24 relative frequencies will be established. From this, a probability, if a program content of a broadcast program corresponds to the predetermined program content, will hourly be established, depending on the time at that weekday. Alternatively, the relative frequencies of positive test results for a broadcast program are separately established for other time intervals of a week day, for example for time intervals of 5 minutes each, so that for one week day 288 relative frequencies will be established. Alternatively, the relative frequencies of positive test results for a broadcast program are separately established for time intervals differing in length of a weekday, wherein the lengths of the time intervals, will be predetermined, for example, depending on the time of day.

Moreover, in establishing the relative frequencies of positive test results for a broadcast program, the timing of the individual test results may be taken into account. For example, in establishing the relative frequencies, more recent test results may be weighted stronger than older test results. In this way, it will advantageously be enabled to faster adopt the probabilities that a program content of a broadcast program corresponds to the predetermined program content, to changes of program of the broadcast program.

Both of the criteria described above for the selection of a broadcast program, which the receiving unit 102 is tuned to in the fifth process step 205, depending on a rating of the broadcast programs or depending on a probability, that a program content of a broadcast program corresponds to the predetermined program content, may also be combined with each other. For example, depending on an actual fill level of the reproduction buffer unit 106, decision is made, which one of the two criteria is used for the selection of the broadcast program. With a high fill level, the rating of the broadcast programs is used for selecting the broadcast program, whereas with a low fill level, the probability, that a program contents of a broadcast programs corresponds to the predetermined program, is used for selecting the broadcast program. For example, a minimum fill level is predetermined and the rating of the broadcast program is used for selecting the broadcast program, if the fill level of the reproduction buffer unit 106 exceeds the minimum fill level, whereas otherwise, the probability that a program content of a broadcast program corresponds to the predetermined program content, is used for selecting the broadcast program.

Alternatively, from the rating of a broadcast program and from the probability, that a program content of the broadcast program corresponds to the predetermined program content, a weighted rating number may be formed, wherein the weight, with which the rating of a broadcast program is received into the rating number, increases with increasing fill level of the reproduction buffer unit 106 in comparison to the weight, with which the probability, that a program content of a broadcast program corresponds to the predetermined program contents, is received into the rating number. The broadcast program, which the receiving unit 102 is tuned to in the process step 205, will then be selected by means of the rating number.

The use of or stronger weighting of the rating of the broadcast program at a higher fill level of the reproduction buffer unit 106, respectively, takes into account that at a higher fill level, the reproduction buffer unit 106 is given more time for the reproduction buffer unit 106 to run empty, in order to find another broadcast program when changing the broadcast program, the program content thereof corresponding to the predetermined program content. The probability for the reproduction buffer unit 106 to run empty during search for a highly rated broadcast program, the program content of which corresponds to the predetermined program content, is relatively low at a higher fill level of the reproduction buffer unit 106, so that it may be acceptable. Whereas, at a lower fill level of the reproduction buffer unit 106, the probability for the reproduction buffer unit 106 to run empty during search for a highly rated broadcast program, the program content of which corresponds to the predetermined program content, is relatively high. Thus, at a lower fill level, the reproduction buffer unit 106 of the receiving unit 102, in process step 205, is preferably tuned to a broadcast program that has a high probability that the program content thereof corresponds to the predetermined program content. In this way, interruption of reproduction of the predetermined program content by running empty of the reproduction buffer unit 106 may be avoided.

The delayed reproduction of the broadcast program buffered by means of the reproduction buffer unit 106 with a reproduction velocity, which is lower than a receiving velocity, with which the buffered broadcast program was received, on the one hand, allows for the reproduction buffer unit 106 to be refilled while receiving a broadcast program, and on the other hand, reduces the velocity, with which the fill level of the reproduction buffer unit 106 decreases, if no broadcast program is received, the program content of which corresponds to the predetermined program content. In this way, it will be allows for the predetermined program content to be continued to be reproduced, upon change of the broadcast program during search for another broadcast program, the program content of which corresponds to the predetermined program content. Moreover, the risk for reproduction of the predetermined program content to be interrupted by running empty of the reproduction buffer unit 106, while, during change of the broadcast program, it will be searched for another broadcast program, the program content of which corresponds to the predetermined program content, is reduced.

Preferably, the reproduction velocity is adjusted depending on a fill level of the reproduction buffer unit 106, wherein the reproduction velocity is increased with increasing fill level of the reproduction buffer unit 106. In this way, the reproduction velocity is decreased at a lower fill level of the reproduction buffer unit 106, to refill the reproduction buffer unit 106 as fast as possible. However, at a high fill level of the reproduction buffer unit 106, the reproduction velocity is decreased to a lesser extend over the receiving velocity, to improve the reproduction quality.

The change of the reproduction velocity is, for example, realized by means of scanning conversion of the buffered broadcast program. Alternatively or in addition, a so-called time-stretching algorithm is used, which allows for a change of the reproduction velocity while simultaneously maintaining the original sound pitch of the buffered broadcast program. In addition to the scanning conversion and/or the time-stretching algorithm, a spectral envelope curve of the broadcast program reproduced in a delayed manner may be adapted to the spectral envelope curve of the received broadcast program. In this way, it is achieved, that the delayed reproduction will affect the reproduction to a minimum extent. Another method may as well be used, allowing delay of the reproduction with the minimum impairment of the reproduction quality.

If the predetermined program content is music, the reproduction velocity, with which the buffered broadcast program is reproduced, is reduced compared to the receiving velocity, with which the broadcast program will be received, for example, by about 1.6 percent. This takes into account, that a test procedure, wherein it is checked, if an actual program content of the received broadcast program is music or voice content, typically requires a time of about 2.5 s, and that a change of the broadcast program in general is required in time intervals of an average of about 160 s, if the predetermined program content is music. Thus, to avoid running empty of the reproduction buffer unit 106, the reproduction velocity needs to be reduced by about 2.5/160, i.e. 1.6%, compared to the receiving velocity. Alternatively, the reproduction velocity may be reduced by 1 to 2%, about 2%, 2 to 5% or less than 1%, compared to the receiving velocity.

Moreover, reproduction of the buffered broadcast program preferably will not be started before a fill level of the reproduction buffer unit 106 is larger than a predetermined fill level. In this way, it is advantageously avoided that the reproduction buffer unit 106, due to lower fill levels, rapidly and frequently runs empty, and that reproduction of the predetermined program contents is frequently interrupted.

In a change of the reproduced broadcast programs (without running empty of the reproduction buffer unit 106), for example, the broadcast program reproduced so far is gradually faded out, before the other broadcast program is gradually faded in. Moreover, between the reproductions of the two broadcast programs, a short reproduction pause may be inserted, for example a reproduction pause of about 1 second. In this way, a smooth and apparent change of the broadcast program is achieved, which advantageously improves the den hearing sensation. Moreover, by the reproduction pause, increase of the fill level of the reproduction buffer unit 106 is advantageously enabled.

Furthermore, the method may enable the user to manually discontinue for example to skip, an actually reproduced broadcast item of the broadcast program, for example a piece of music, if the predetermined program content is music. In this way, the receiving unit 102 is tuned to another broadcast program, so that instead of the original reproduced broadcast program, the other broadcast program will be received. Moreover, the reproduction buffer unit 106 is emptied and the method is continued in the second process step 202. The broadcast program, the broadcast item of which was discontinued or skipped, may, in this case, in the fifth process step 205 not be selected for a predetermined time span, for example for a typical duration of a piece of music, if the predetermined program content is music, so that re-reproducing of the broadcast item is avoided.

Moreover, an operative action of a user max cause a portion of a buffered broadcast program not to be reproduced and, instead, reproduction is continued in a portion of the broadcast program to be received later, without the receiving unit to be tuned to the other broadcast program or the broadcast program reproduced until the operative action not to be taken into account for a predetermined time span during execution of step (e). I.e., a portion of the buffered broadcast program is “skipped” during reproduction. This portion may immediately be removed from the reproduction buffer unit or may remain there for the time being. This procedure is especially useful, if a reproduction buffer unit, besides a piece of music reproduced until the operative action, comprises a program content piece received following the piece of music.

Furthermore, the method may be combined with a so-called time-shift function, for the timely delayed reproduction of a broadcast program. In this way, the user is enabled to discontinue reproduction of a broadcast program, wherein the reproduction buffer unit 106 is filled during interruption. Moreover, the user may be enabled to retrieve broadcast program previously stored, so that this broadcast program is reproduced, wherein the reproduction buffer unit 106 is filled during reproduction thereof. Moreover, the user may be enabled to switch between various broadcast programs previously stored. Moreover, it may be provided, that the broadcast receiver device 100, following termination of the reproduction of broadcast programs, is caused to continue in the background, and buffers a broadcast program, which may directly be reproduced upon re-activation of the reproduction. The broadcast receiver device 100, for example, turns off after a predetermined turn-off time and permanently stores the buffered broadcast program, to make it available upon switching on again the broadcast receiver device 100.

1. A method for reproducing broadcast programs, comprising the steps of:
(a) receiving a broadcast program;
(b) checking, if an actual program content of the received broadcast program corresponds to a predetermined program content;
(c) buffering the received broadcast program, as long as the actual program content corresponds to the predetermined program content;
(d) reproducing the buffered broadcast program with a reproduction velocity which is lower than a receiving velocity, with which the buffered broadcast program was received; and
(e) tuning the receiving unit to another broadcast program, so that instead of the received broadcast program the other broadcast program will be received, as soon as one of the actual program content does not correspond to the predetermined program content.

2. The method according to claim 1, wherein the steps (b) to (e) are re-executed.

3. The method of claim 1, wherein the reproduction velocity is set depending on a fill level of a reproduction buffer unit.

4. The method of claim 1, wherein the reproduction velocity is set by means of a scanning conversion of the buffered broadcast program.

5. The method of claim 1, wherein reproduction of the buffered broadcast program will not be started before a fill level of a reproduction buffer unit is larger than a predetermined fill level.

6. The method of claim 1, wherein a user of the broadcast receiver device defines one broadcast program or several broadcast program, and one of the broadcast programs defined is selected as the other broadcast program.

7. The method of claim 1, wherein a user of the broadcast receiver device rates a broadcast program or several broadcast programs, and one of the rated broadcast programs is selected by means of the rating as the other broadcast program.

8. The method of claim 1, wherein for each broadcast program or for several broadcast programs a probability is determined, that a program content of the broadcast program corresponds to the predetermined program content, and one of the broadcast programs is selected by means of the probability as the other broadcast program.

9. The method of claim 1, wherein buffering of the received broadcast program is continued after reproduction of the buffered broadcast program has been interrupted.

10. The method of claim 1, wherein following tuning of a receiving unit to the other broadcast program, reproduction of the buffered broadcast programs is continued.

11. The method of claim 1, wherein the predetermined program content does not comprise a voice content, or the predetermined program content does not comprise music.

12. The method of claim 1, wherein the received broadcast program is reproduced, wherein an operative action of a user of the broadcast receiver device causes a receiving unit to be tuned to the other broadcast program, so that, instead of the reproduced broadcast program, the other broadcast program will be received, a reproduction buffer unit will be emptied, and the broadcast program reproduced until the operative action will not be taken into account for a predetermined time span during execution of step (e).

13. A broadcast receiver device for reproducing broadcast programs, comprising:
a receiving unit, configured to receive a broadcast program and tune to another broadcast program, so that, instead of the received broadcast program, the other broadcast program will be received as soon as an actual program content of the received broadcast program does not correspond to a predetermined program content;
a calculating unit configured to check if an actual program content of broadcast program received by the receiving unit corresponds to a predetermined program content,
a reproduction buffer unit configured to buffer a broadcast program received by the receiving unit, as long as an actual program content of the received broadcast program corresponds to a predetermined program content; and
a reproduction unit, configured to reproduce a broadcast program buffered in the reproduction buffer unit with a reproduction velocity that is lower than a receiving velocity, with which the buffered broadcast program was received by the receiving unit.

14. A method for reproducing broadcast programs by means of a broadcast receiver device, which comprises a receiving unit, a reproduction buffer unit, a reproduction unit and a calculating unit, comprising the steps of:
(a) receiving a broadcast program by means of the receiving unit;
(b) checking, if an actual program content of the received broadcast program corresponds to a predetermined program content, by means of the calculating unit;
(c) buffering the received broadcast program in the reproduction buffer unit, as long as the actual program content corresponds to the predetermined program content;
(d) reproducing the buffered broadcast program by means of the reproduction unit with a reproduction velocity, which is lower than a receiving velocity, with which the buffered broadcast program was received; and
(e) tuning the receiving unit to another broadcast program, so that instead of the received broadcast program the other broadcast program will be received, as soon as one of the actual program content does not correspond to the predetermined program content.
